(19) United States
(12) Patent Application Publication
(10) Pub. No.: US 2014/0017597 A1
(43) Pub. Date: Jan. 16, 2014

(54) FUEL CELL

(71) Applicant: MURATA MANUFACTURING CO., LTD., Nagaokakyo-shi (JP)

(72) Inventor: Osamu Yokokura, Nagaokakyo-Shi (JP)

(73) Assignee: MURATA MANUFACTURING CO., LTD., Nagaokakyo-Shi (JP)

(21) Appl. No.: 14/030,856

(22) Filed: Sep. 18, 2013

Related U.S. Application Data
(63) Continuation of application No. PCT/JP2012/057496, filed on Mar. 23, 2012.

(30) Foreign Application Priority Data
Mar. 25, 2011 (JP) 2011-067326

(51) Int. Cl. H01M 8/02

(52) U.S. Cl. CPC H01M 8/0258
USPC 429/482

(57) ABSTRACT

Provided is a solid oxide fuel cell having high power generation efficiency, and includes: a power generating element having a solid oxide electrolyte layer, a first electrode and a second electrode; a first separator; a second separator; and a first porous body. The first separator has a first separator body arranged on the first electrode, and a plurality of first channel forming portions. A plurality of first channel forming portions are arranged at intervals from one another so as to protrude toward the first electrode 32a side from the first separator body. A plurality of first channel forming portions dividedly form a plurality of first channels between the first separator body and the first electrode. The first porous body is arranged between the first channel forming portion and the first electrode.

This is a continuation of application Serial Number PCT/JP2012/057496, filed Mar. 23, 2012, the entire contents of which is incorporated herein by reference.

### TECHNICAL FIELD

The present invention relates to a fuel cell. In particular, the present invention relates to a solid oxide fuel cell.

### BACKGROUND ART

In recent years, attention to fuel cells has been increased as a new energy source. Examples of fuel cells include solid oxide fuel cells (SOFC), molten carbonate fuel cells, phosphoric acid fuel cells and polymer electrolyte fuel cells. Among these fuel cells, solid oxide fuel cells do not necessarily require the use of a liquid component and can be internally modified when a hydrocarbon fuel is used. Therefore, research and development on solid oxide fuel cells have been vigorously conducted.

For example, Patent Document 1 discloses a solid oxide fuel cell shown in FIG. 15. As shown in FIG. 15, a solid oxide fuel cell 100 described in Patent Document 1 includes a plurality of laminated power generating elements 101. Each of a plurality of power generating elements 101 includes a solid oxide electrolyte layer 102. The solid oxide electrolyte layer 102 is held between an air electrode 103 and a fuel electrode 104. A separator 105 is provided between adjacent power generating elements 101.

A plurality of grooves 105a extending along a first direction are formed on a surface of the separator 105 on the air electrode 103 side. The plurality of grooves 105a dividedly form an oxidant gas channel. An oxidant gas is supplied to the air electrode 103 via the oxidant gas channel dividedly formed by the plurality of grooves 105a. On the other hand, a plurality of grooves 105b are formed on a surface of the separator 105 on the fuel electrode 104 side. Each of a plurality of grooves 105b extends along a second direction perpendicular to the first direction. The plurality of grooves 105b dividedly form a fuel gas channel. A fuel gas is supplied to the fuel electrode 104 via the fuel gas channel dividedly formed by the plurality of grooves 105b.

In the fuel cell 100, the separator 105 is formed of a lanthanum chromite-based ceramic having conductivity.

### PRIOR ART DOCUMENTS

### Patent Documents

Patent Document 1: JP 11-329462 A

### DISCLOSURE OF THE INVENTION

### Problem to be Solved by the Invention

In recent years, it has been increasingly desired to enhance power generation efficiency of fuel cells.

The present invention has been devised in view of the situation described above, and an object of the present invention is to provide a solid oxide fuel cell having high power generation efficiency.

### Means for Solving the Problem

A fuel cell according to the present invention includes a power generating element, a first separator, a second separator and a first porous body. The power generating element has a solid oxide electrolyte layer, a first electrode and a second electrode. The first electrode is arranged on one principal surface of the solid oxide electrolyte layer. The second electrode is arranged on the other principal surface of the solid oxide electrolyte layer. The first separator has a first separator body and a plurality of first channel forming portions. The first separator body is arranged on the first electrode. A plurality of first channel forming portions are arranged at intervals from one another so as to protrude toward the first electrode side from the first separator body. A plurality of first channel forming portions dividedly form a plurality of first channels between the first separator body and the first electrode. The second separator has a second separator body and a plurality of second channel forming portions. The second separator body is arranged on the second electrode. A plurality of second channel forming portions are arranged at intervals from one another so as to protrude toward the second electrode side from the second separator body. A plurality of second channel forming portions dividedly form a plurality of second channels between the second separator body and the second electrode. The first porous body is arranged between the first channel forming portion and the first electrode.

In a specific aspect of the fuel cell according to the present invention, the first porous body is provided so as to cover a portion of the first electrode which faces the first channel.

In another specific aspect of the fuel cell according to the present invention, the fuel cell further includes a second porous body arranged between the second channel forming portion and the second electrode.

In yet specific aspect of the fuel cell according to the present invention, the second porous body is provided so as to cover a portion of the second electrode which faces the second channel.

In still another aspect of the fuel cell according to the present invention, the first and second porous bodies are formed of the same material.

In yet another aspect of the fuel cell according to the present invention, the first separator has a via hole electrode extending from a surface of the first channel forming portion on a side opposite to the first separator body to a surface of the first separator body on a side opposite to the first channel forming portion. The first porous body is formed of a conductive member.

In still another aspect of the fuel cell according to the present invention, the first porous body is formed of a conductive ceramic.

In another aspect of the fuel cell according to the present invention, the first porous body is formed of the same material as that of the first electrode.

In still another aspect of the fuel cell according to the present invention, the first separator has a via hole electrode extending from a surface of the first channel forming portion on a side opposite to the first separator body to a surface of the first separator body on a side opposite to the first channel forming portion. The first porous body has a porous body main body formed of an insulating member, and an electrode formed in the porous body main body and electrically connecting the via hole electrode and the first electrode.

In yet another aspect of the fuel cell according to the present invention, the porous body main body is formed of the same material as that of the first channel forming portion.

In another aspect of the fuel cell according to the present invention, the porous body main body is formed of the same material as that of the first separator body.

In a further different aspect of the fuel cell according to the present invention, the porous body main body is formed of the same material as that of the first channel forming portion and the first separator body.

### Advantageous Effect of the Invention

According to the present invention, a solid oxide fuel cell having high power generation efficiency can be provided.

### BRIEF EXPLANATION OF DRAWINGS

FIG. 1 is a schematic exploded perspective view of a fuel cell according to a first embodiment.

FIG. 2 is a schematic plan view of a first separator body in the first embodiment.

FIG. 3 is a schematic plan view of a first channel forming portion in the first embodiment.

FIG. 4 is a schematic plan view of a first porous body in the first embodiment.

FIG. 5 is a schematic plan view of an air electrode layer in the first embodiment.

FIG. 6 is a schematic plan view of a solid oxide electrolyte layer in the first embodiment.

FIG. 7 is a schematic plan view of a fuel electrode layer in the first embodiment.

FIG. 8 is a schematic plan view of a second porous body in the first embodiment.

FIG. 9 is a schematic plan view of a second channel forming portion in the first embodiment.

FIG. 10 is a schematic plan view of a second separator body in the first embodiment.

FIG. 11 is a schematic sectional view in the line XI-XI in FIG. 3.

FIG. 12 is a schematic sectional view in the line XII-XII in FIG. 9.

FIG. 13 is a schematic sectional view of a fuel cell according to a second embodiment.

FIG. 14 is a schematic sectional view of the fuel cell according to the second embodiment.

FIG. 15 is a schematic exploded perspective view of a solid oxide fuel cell described in Patent Document 1.

### DESCRIPTION OF CARRYING OUT THE INVENTION

One example of a preferred embodiment of carrying out the present invention will be described below. It is to be noted that the embodiments described below are merely illustrative. The present invention is in no way limited to the embodiments described below.

In each drawing referred to in embodiments below, members having substantially the same function are denoted by the same symbols. Drawings referred to in the embodiments, etc., are schematically described, and the ratio of dimensions, etc., of an object drawn in the drawing may be different from the ratio of dimensions, etc., of the actual object. The dimension ratio, etc., of an object may be different between drawings. A specific dimension ratio, etc., of an object should be inferred by considering the descriptions below.

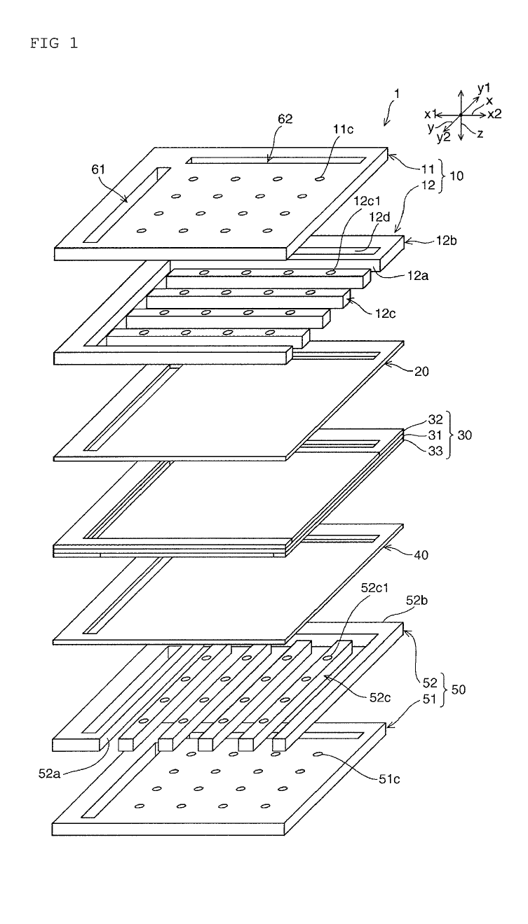

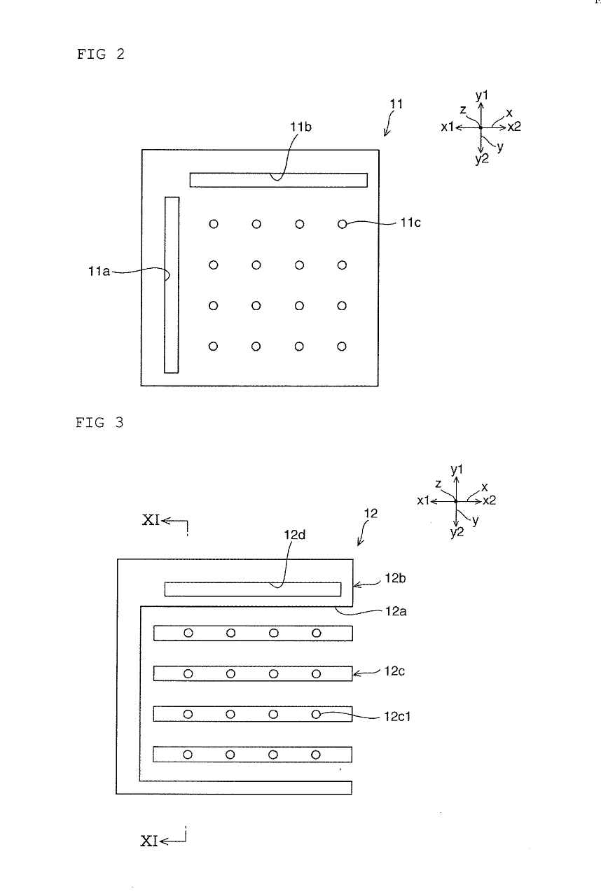

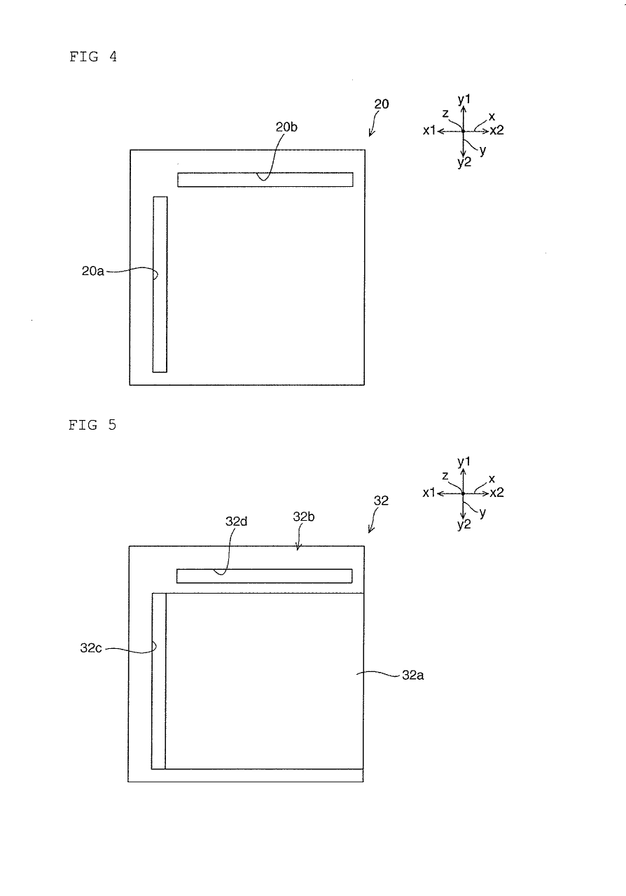

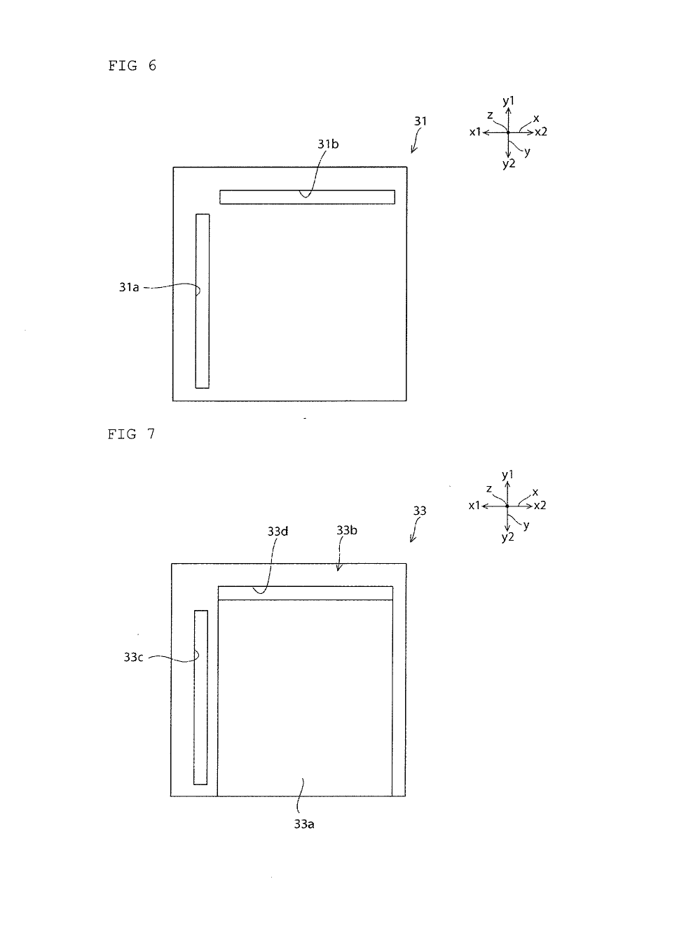

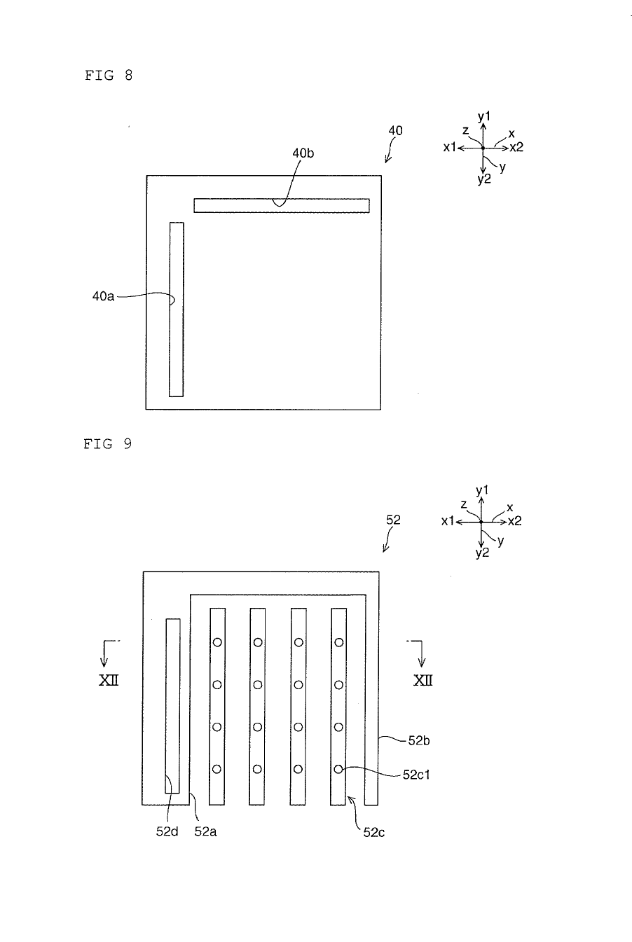

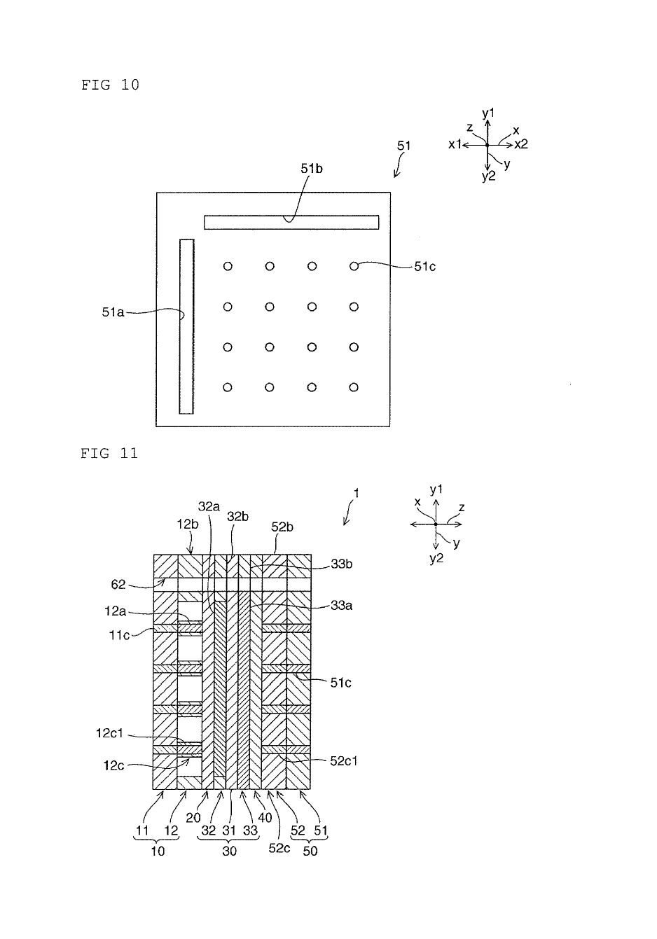

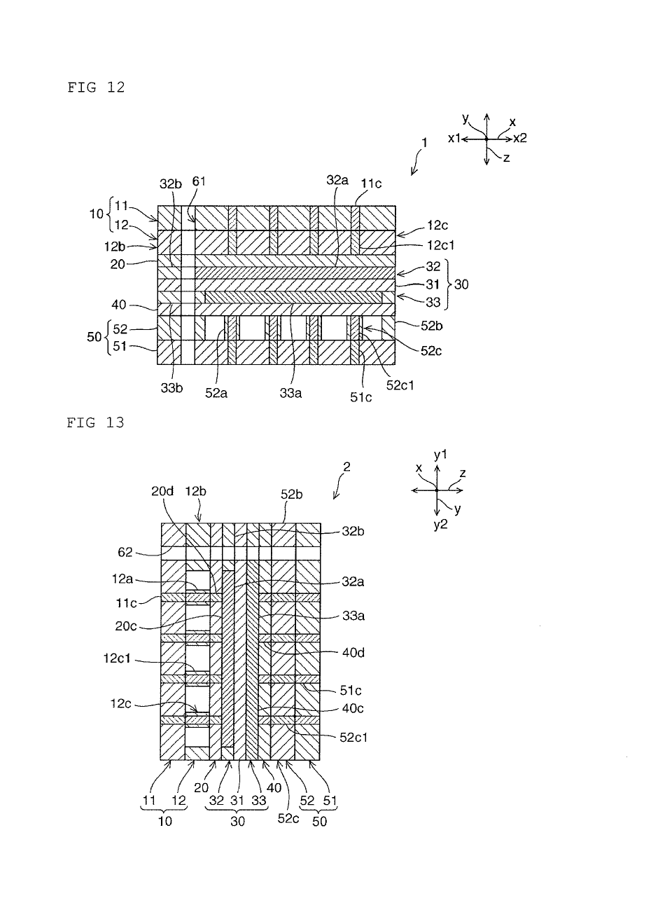

FIG. 1 is a schematic exploded perspective view of a fuel cell according to a first embodiment. FIG. 2 is a schematic plan view of a first separator body in the first embodiment. FIG. 3 is a schematic plan view of a first channel forming portion in the first embodiment. FIG. 4 is a schematic plan view of a first porous body in the first embodiment. FIG. 5 is a schematic plan view of an air electrode layer in the first embodiment. FIG. 6 is a schematic plan view of a solid oxide electrolyte layer in the first embodiment. FIG. 7 is a schematic plan view of a fuel electrode layer in the first embodiment. FIG. 8 is a schematic plan view of a second porous body in the first embodiment. FIG. 9 is a schematic plan view of a second channel forming portion in the first embodiment. FIG. 10 is a schematic plan view of a second separator body in the first embodiment. FIG. 11 is a schematic sectional view in the line XI-XI in FIG. 3. FIG. 12 is a schematic sectional view in the line XII-XII in FIG. 9.

As shown in FIGS. 1, 11 and 12, a fuel cell 1 of this embodiment includes a first separator 10, a first porous body 20, a power generating element 30, a second porous body 40 and a second separator 50. In the fuel cell 1, the first separator 10, the first porous body 20, the power generating element 30, the second porous body 40 and the second separator 50 are laminated in this order.

The fuel cell 1 of the present embodiment include only one laminated body of the first and second porous bodies 20 and 40 and the power generating element 30. However, the present invention is not limited to this configuration. For example, the fuel cell of the present invention may include a plurality of laminated bodies of first and second porous bodies and a power generating element. In this case, adjacent laminated bodies are isolated from each other by a separator.

Power Generating Element 30

The power generating element 30 is a portion where an oxidant gas supplied from an oxidant gas channel (manifold for oxidant gas) 61 and a fuel gas supplied from a fuel gas channel (manifold for fuel gas) 62 react with each other to generate power. The oxidant gas can be formed by, for example, an oxygen-containing gas such as air or oxygen gas, etc. The fuel gas may be a gas containing a hydrogen gas, and a hydrocarbon gas such as a carbon monoxide gas, etc.

Solid Oxide Electrolyte Layer 31

The power generating element 30 includes a solid oxide electrolyte layer 31. The solid oxide electrolyte layer 31 is preferably one having high ionic conductivity. The solid oxide electrolyte layer 31 can be formed from, for example, stabilized zirconia or partially stabilized zirconia. Specific examples of stabilized zirconia include 10 mol % yttria stabilized zirconia (10YSZ) and 11 mol % scandia stabilized zirconia (11ScSZ). A specific example of partially stabilized zirconia is 3 mol % yttria stabilized zirconia (3YSZ). The solid oxide electrolyte layer 31 can also be formed from, for example, a ceria-based oxide doped with Sm, Gd and the like, or a perovskite type oxide, such as La_{0.8}Sr_{0.2}Ga_{0.8}Mg_{0.2}O_{(3-δ)}, which has LaGaO₃ as a base and in which La and Ga are partially substituted with Sr and Mg, respectively.

Through holes 31a and 31b forming parts of channels 61 and 62 are formed in the solid oxide electrolyte layer 31 as shown in FIG. 6.

The solid oxide electrolyte layer 31 is held between an air electrode layer 32 and a fuel electrode layer 33. That is, the air electrode layer 32 is formed on one principal surface of the solid oxide electrolyte layer 31, and the fuel electrode layer 33 is formed on the other principal surface.

Air Electrode Layer 32

As shown in FIG. 5, the air electrode layer 32 has an air electrode 32a and a peripheral portion 32b. Through holes 32c and 32d forming parts of channels 61 and 62 are formed in the peripheral portion 32b.

The air electrode 32a is a cathode. In the air electrode 32a, oxygen captures electrons to form oxygen ions. The air electrode 32a is preferably one that is porous, has high electron conductivity and is resists a solid-solid reaction with the solid oxide electrolyte layer 31, etc., at a high temperature. The air electrode 32a can be formed from, for example, scandia stabilized zirconia (ScSZ), indium oxide doped with Sn, a PrCoO₃-based oxide, a LaCoO₃-based oxide or a LaMnO₃-based oxide. Specific examples of the LaMnO₃-based oxide include La_{0.8}Sr_{0.2}MnO₃ (common name: LSM), La_{0.8}Sr_{0.2}Co_{0.2}Fe_{0.8}O₃ (common name: LSCF) and La_{0.6}Ca_{0.4}MnO₃ (common name: LCM).

The peripheral portion 32b can be formed from, for example, a material similar to that of first and second separator bodies 11 and 51 described below.

Fuel Electrode Layer 33

As shown in FIG. 7, the fuel electrode layer 33 has a fuel electrode 33a and a peripheral portion 33b. Through holes 33c and 33d forming parts of channels 61 and 62 are formed in the peripheral portion 33b.

The fuel electrode 33a is an anode. In the fuel electrode 33a, oxygen ions and a fuel gas react with each other to release electrons. The air electrode 33a is preferably one that is porous, has high electron conductivity and is resistant to a solid-solid reaction with the solid oxide electrolyte layer 31, etc., at a high temperature. The fuel electrode 33a can be formed from, for example, NiO, a porous cermet of yttria stabilized zirconia (YSZ)/nickel metal or a porous cermet of scandia stabilized zirconia (ScSZ)/nickel metal.

First Separator 10

As shown in FIGS. 1, 11 and 12, the first separator 10 is arranged on the air electrode layer 32 of the power generating element 30. The first separator 10 has a function to form a channel 12a for supplying to the air electrode 32a an oxidant gas supplied from the oxidant gas channel 61, and a function to draw the air electrode 32a to outside the fuel cell 1. In a fuel cell including a plurality of power generating elements, the first separator also has a function to separate a fuel gas and an oxidant gas.

The first separator 10 has a first separator body 11 and a first channel forming portion 12 composed of linear projections. The first separator body 11 is arranged on the air electrode 32a. Through holes 11a and 11b forming parts of channels 61 and 62 are formed in the first separator body 11.

The first channel forming portion 12 is arranged between the first separator body 11 and the air electrode layer 32. The first channel forming portion 12 has a peripheral portion 12b and a plurality of channel forming portions 12c. A through hole 12d forming part of the fuel gas channel 62 is formed in the peripheral portion 12b.

Each of a plurality of channel forming portions 12c is provided so as to protrude toward the air electrode layer 32 side from a surface of the first separator body 11 on the air electrode layer 32 side. Each of a plurality of channel forming portions 12c is linearly provided along an x direction. A plurality of channel forming portions 12c are arranged at intervals from one another along a y direction. The channel 12a is dividedly formed between adjacent channel forming portions 12c and between the channel forming portion 12c and the peripheral portion 12b.

The materials of the first separator body 11 and the first channel forming portion 12 are not particularly limited. Each of the first separator body 11 and the first channel forming portion 12 can be formed from, for example, stabilized zirconia or partially stabilized zirconia. Each of the first separator body 11 and the first channel forming portion 12 can also be formed from, for example, a conductive ceramic such as lanthanum chromite or strontium titanate containing a rare earth metal, or an insulating ceramic such as alumina or zirconium silicate.

A plurality of via hole electrodes 12c1 are embedded in each of a plurality of channel forming portions 12c. A plurality of via hole electrodes 12c1 are formed so as to extend through a plurality of channel forming portions 12c in a z direction. In the first separator body 11, a plurality of via hole electrodes 11c are formed at positions corresponding to a plurality of via hole electrodes 12c1. A plurality of via hole electrodes 11c are formed so as to extend through the first separator body 11. The plurality of via hole electrodes 11c and via hole electrodes 12c1 form a plurality of via hole electrodes extending from a surface of the channel forming portion 12c on a side opposite to the first separator body 11 to a surface of the first separator body 11 on a side opposite to the channel forming portion 12c.

The materials of the via hole electrode 11c and the via hole electrode 12c1 are not particularly limited. Each of the via hole electrode 11c and the via hole electrode 12c1 can be formed from, for example, an Ag—Pd alloy, an Ag—Pt alloy, lanthanum chromite (LaCrO₃) containing an alkali earth metal, lanthanum ferrate (LaFeO₃), or lanthanum strontium manganite (LSM).

Second Separator 50

The second separator 50 is arranged on the fuel electrode layer 33 of the power generating element 30. The second separator 50 has a function to form a channel 52a for supplying to the fuel electrode 33a a fuel gas supplied from the fuel gas channel 62, and a function to draw the fuel electrode 33a to outside the fuel cell 1. In a fuel cell including a plurality of power generating elements, the second separator also has a function to separate a fuel gas and an oxidant gas.

The second separator 50 has a second separator body 51 and a second channel forming portion 52 composed of linear projections. The second separator body 51 is arranged on the fuel electrode 33a. Through holes 51a and 51b forming parts of channels 61 and 62 are formed in the second separator body 51.

The second channel forming portion 52 is arranged between the second separator body 51 and the fuel electrode layer 33. The second channel forming portion 52 has a peripheral portion 52b and a plurality of channel forming portions 52c. A through hole 52d forming part of the fuel gas channel 62 is formed in the peripheral portion 52b.

Each of a plurality of channel forming portions 52c is provided so as to protrude toward the fuel electrode layer 33 side from a surface of the second separator body 51 on the fuel electrode layer 33 side. Each of a plurality of channel forming portions 52c are linearly provided along a y direction perpendicular to a direction in which the channel forming portion 12c extends. A plurality of channel forming portions 52c are arranged at intervals from one another along an x direction. The channel 52a is dividedly formed between adjacent channel forming portions 52c and between the channel forming portion 52c and the peripheral portion 52b. Thus, the direction in which the channel 52a extends is orthogonal to the direction in which the channel 12a extends.

The materials of the second separator body 51 and the second channel forming portion 52 are not particularly limited. Each of the second separator body 51 and the second channel forming portion 52 can be formed from, for example, stabilized zirconia or partially stabilized zirconia. Each of the second separator body 51 and the second channel forming portion 52 can also be formed from, for example, a conductive ceramic such as lanthanum chromite or strontium titanate containing a rare earth metal, or an insulating ceramic such as alumina or zirconium silicate.

A plurality of via hole electrodes 52c1 are embedded in each of a plurality of channel forming portions 52c. A plurality of via hole electrodes 52c1 are formed so as to extend through a plurality of channel forming portions 52c in a z direction. In the second separator body 51, a plurality of via hole electrodes 51c are formed at positions corresponding to a plurality of via hole electrodes 52c1. A plurality of via hole electrodes 51c are formed so as to extend through the second separator body 51. The plurality of via hole electrodes 51c and via hole electrodes 52c1 form a plurality of via hole electrodes extending from a surface of the channel forming portion 52c on a side opposite to the second separator body 51 to a surface of the second separator body 51 on a side opposite to the channel forming portion 52c.

The materials of the via hole electrode 51c and the via hole electrode 52c1 are not particularly limited. Each of the via hole electrode 51c and the via hole electrode 52c1 can be formed from, for example, an Ag—Pd alloy, an Ag—Pt alloy, a nickel metal, an yttria stabilized zirconia (YSZ)/nickel metal or a scandia stabilized zirconia (ScSZ)/nickel metal.

First Porous Body 20 and Second Porous Body 40

The first porous body 20 is arranged between the first channel forming portion 12c and the air electrode 32a. The first porous body 20 is formed so as to cover a portion of the air electrode 32a which faces the channel 12a. Specifically, the first porous body 20 is formed in this embodiment so as to cover substantially the whole of the air electrode 32a.

On the other hand, a second porous body 40 is arranged between the second channel forming portion 52c and the fuel electrode 33a. The second porous body 40 is formed so as to cover a portion of the fuel electrode 33a which faces the channel 52a. Specifically, the second porous body 40 in this embodiment is formed so as to cover substantially the whole of the fuel electrode 33a.

In the present invention, the first porous body should be arranged between the first channel forming portion and the air electrode. For example, the first porous body may be arranged only between the first channel forming portion and the air electrode. The second porous body should be arranged between the second channel forming portion and the fuel electrode. For example, the second porous body may be arranged only between the second channel forming portion and the fuel electrode.

Through holes 20a, 20b, 40a and 40b forming parts of channels 61 and 62 are formed in each of the first and second porous bodies 20 and 40.

In this embodiment, each of the first and second porous bodies 20 and 40 has open cells. The porosity of each of the first and second porous bodies 20 and 40 is preferably 5% to 70%, more preferably 15% to 60%. The thickness of each of the first and second porous bodies 20 and 40 may be the same, or may be different. The thickness can be arbitrarily set according to materials used to form the electrode, the separator and the porous body with consideration given to required characteristics of the fuel cell.

The materials of the first and second porous bodies 20 and 40 are not particularly limited. In this embodiment, each of the first and second porous materials 20 and 40 is formed of a conductive member. Therefore, the air electrode 32a is electrically connected to the via hole electrodes 12c1 and 11c through the first porous body 20. The fuel electrode 33a is electrically connected to the via hole electrodes 52c1 and 51c through the second porous body 40.

The first porous body 20 can be formed from a conductive ceramic or the same material as that of the air electrode 32a. The second porous body 40 can be formed from a conductive ceramic or the same material as that of the fuel electrode 33a. As the conductive ceramic, lanthanum chromite containing a rare earth metal, a titanic acid compound, or the like can be used to mold the porous body.

In a fuel cell 100 described in Patent Document 1, an oxidant gas and a fuel gas are supplied to an air electrode 103 and a fuel electrode 104 via a plurality of grooves 105a and 105b. Therefore, portions of the air electrode 103 and the fuel electrode 104, which face the grooves 105a and 105b, are supplied with an oxidant gas and a fuel gas. However, portions of the air electrode 103 and the fuel electrode 104, which are in contact with a separator 105, are supplied with substantially no oxidant gas and fuel gas. Therefore, contribution to power generation of portions of the air electrode 103 and the fuel electrode 104, which are in contact with the separator 105, is small.

In contrast, the first porous body 20 in this embodiment is arranged between the air electrode 32a and the first channel forming portion 12c. Therefore, an oxidant gas from the channel 12a diffuses toward the z direction and also diffuses toward the x and y directions in the first porous body 20. As a result, the oxidant gas is supplied to not only a portion of the air electrode 32a which is located below the channel 12a, but also a portion located below the first channel forming portion 12c.

Further, the second porous body 40 is arranged in this embodiment between the fuel electrode 33a and the second channel forming portion 52c. Therefore, a fuel gas from the channel 52a diffuses toward the z direction and also diffuses toward the x and y directions in the second porous body 40. As a result, the fuel gas is supplied to not only a portion of the fuel electrode 33a which is located below the channel 52a, but also a portion located below the second channel forming portion 52c.

Therefore, in this embodiment, contribution to power generation of portions of the air electrode 32a and the fuel electrode 33a, which are located below the channel forming portions 12c and 52c, is large. That is, substantially the whole of the air electrode 32a and the fuel electrode 33a significantly contributes to power generation. Accordingly, high power efficiency can be achieved.

In this embodiment, the first porous body 20 is provided so as to cover a portion of the air electrode 32a which faces the channel 12a. Therefore, an oxidant gas can be more efficiently supplied to a portion of the air electrode 32a which is located below the first channel forming portion 12c as compared to a case where the first porous body 20 is provided only between the air electrode 32a and the first channel forming portion 12c. Further, the second porous body 40 is provided so as to cover a portion of the fuel electrode 33a which faces the channel 52a. Therefore, a fuel gas can be more efficiently supplied to a portion of the fuel electrode 33a which is located below the second channel forming portion 52c as compared to a case where the second porous body 40 is provided only between the fuel electrode 33a and the second channel forming portion 52c. Accordingly, higher power efficiency can be achieved.

In this embodiment, the porous bodies 20 and 40 are provided so as to cover portions of the air electrode 32a and the fuel electrode 33a which face the channels 12a and 52a. That is, the porous bodies 20 and 40 are provided in a planar form. Therefore, for example, stiffness of the power generating element 30 can be enhanced as compared to a case where the porous bodies 20 and 40 are provided in a stripe form only below the channel forming portions 12c and 52c. Accordingly, occurrence of deformation such as warpage in the power generating element 30 can be suppressed. Accordingly, long-term reliability of the fuel cell 1 can be improved.

In particular, the air electrode 32a and the fuel electrode 33a in this embodiment are harder to be deformed because the surfaces of the air electrode 32a and the fuel electrode 33a are sintered with the first and second porous bodies 20 and 40. Therefore, long-term reliability of the fuel cell 1 can be more effectively improved.

Further, the solid oxide electrolyte layer 31 can be made thin without significantly reducing stiffness of the power generating element 30. Accordingly, power generation efficiency can be further enhanced. In particular, the initial power generation efficiency can be further enhanced.

For more effectively suppressing warpage of the power generating element 30, it is preferable that the first porous body 20 and the second porous body 40 are formed of the same material. For enhancing stiffness of the power generating portion 20, it is preferable that the firing shrinkage rate of the material of the power generating portion 20 is large as compared to the firing shrinkage rate of the power generating portion 30, and the linear thermal expansion coefficient of the material of the power generating portion 20 is small as compared to the firing shrinkage rate of the power generating portion 30. Consequently, compressive stress is applied to the power generating portion 20 to enhance stiffness.

Here, the term “formed of the same material” means that principal components are the same, and do not necessarily mean that components are exactly the same including impurities.

In this embodiment, a case has been described where both the first and second porous bodies 20 and 40 are provided. However, the present invention is not limited to this configuration. In the present invention, for example, only one of the first and second porous bodies may be provided.

Other examples of preferred embodiments of carrying out the present invention will be described below. In the descriptions below, members having substantially the same functions as those in the first embodiment are denoted by the same symbols, and explanations thereof are omitted.

### Second Embodiment

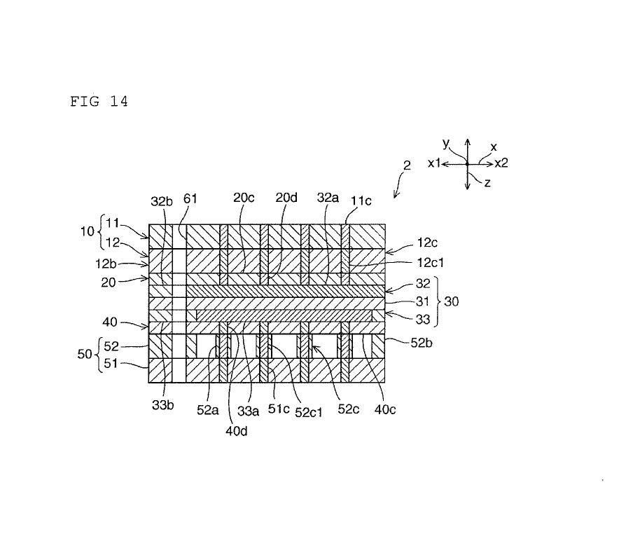

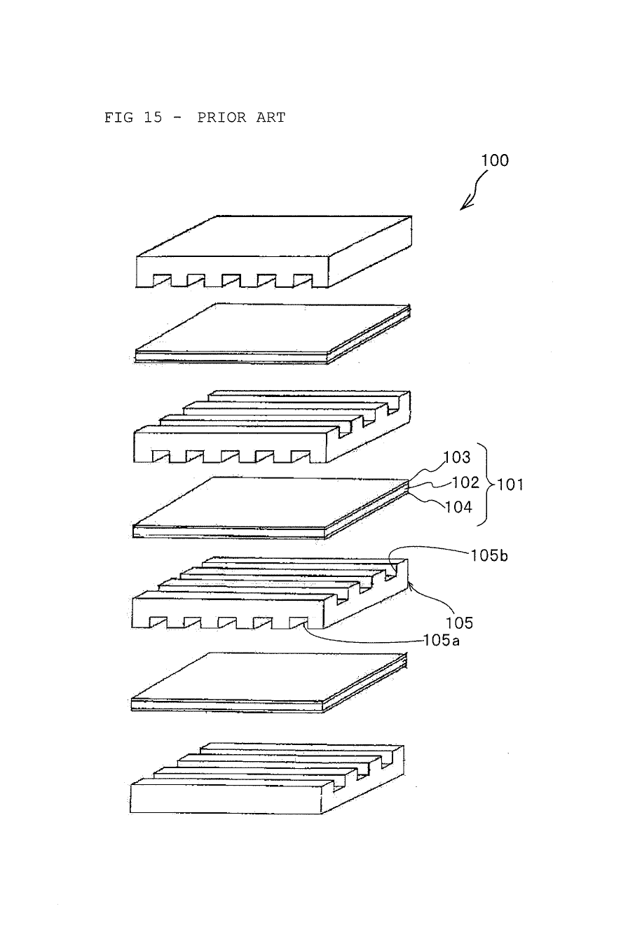

FIG. 13 is a schematic sectional view of a fuel cell according to a second embodiment. FIG. 14 is a schematic sectional view of the fuel cell according to the second embodiment.

A fuel cell 2 of this embodiment shown in FIGS. 13 and 14 has substantially the same configuration as that of the fuel cell 1 of the first embodiment except for the configurations of first and second porous bodies 20 and 40. Therefore, the configurations of the first and second porous bodies 20 and 40 in this embodiment are described, and for others features, descriptions of the first embodiment are incorporated.

In this embodiment, the first porous body 20 has a porous body main body 20c and a plurality of via hole electrodes 20d. The porous body main body 20c is formed of an insulating member. In this embodiment, the porous body main body 20c is formed of the same material as that of the first channel forming portion 12c.

A plurality of via hole electrodes 20d are formed in the porous body main body 20c. Each of a plurality of via hole electrodes 20d extends through the porous body main body 20c. A plurality of via hole electrodes 20d are provided at positions corresponding to the positions of via hole electrodes 12c1. The air electrode 32a and the via hole electrode 12c1 are electrically connected by the plurality of via hole electrodes 20d. In this embodiment, a plurality of via hole electrodes 20d are formed of the same material as that of the via hole electrode 12c1.

The second porous body 40 has a porous body main body 40c and a plurality of via hole electrodes 40d. The porous body main body 40c is formed of an insulating member. In this embodiment, the porous body main body 40c is formed of the same material as that of the second channel forming portion 52c.

A plurality of via hole electrodes 40d are formed in the porous body main body 40c. Each of a plurality of via hole electrodes 40d extends through the porous body main body 40c. A plurality of via hole electrodes 40d are provided at positions corresponding to the positions of via hole electrodes 52c1. The fuel electrode 33a and the via hole electrode 52c1 are electrically connected by the plurality of via hole electrodes 40d. In this embodiment, a plurality of via hole electrodes 40d are formed of the same material as that of the via hole electrode 52c1.

In this embodiment, high power generation efficiency can be achieved as in the first embodiment. Further, warpage of the power generating element 30 can be suppressed.

### DESCRIPTION OF REFERENCE SYMBOLS

1, 2 . . . fuel cell
10 . . . first separator
11 . . . first separator body
11a, 11b . . . through hole
11c . . . via hole electrode
12 . . . first channel forming portion
12a . . . first channel
12b . . . peripheral portion
12c . . . first channel forming portion
12c1 . . . via hole electrode
12d . . . through hole
20 . . . first porous body
20a, 20b, 40a, 40b . . . through hole
20c . . . porous body main body
20d . . . via hole electrode
30 . . . power generating element
31 . . . solid oxide electrolyte layer
31a, 31b . . . through hole
32 . . . air electrode layer
32a . . . air electrode
32b . . . peripheral portion
32c, 32d . . . through hole
33 . . . fuel electrode layer
33a . . . fuel electrode
33b . . . peripheral portion
33c, 33d . . . through hole
40 . . . second porous body
40c . . . porous body main body
40d . . . via hole electrode
50 . . . second separator
51 . . . second separator body
51a, 51b . . . through hole
51c . . . via hole electrode
52 . . . second channel forming portion
52a . . . second channel
52b . . . peripheral portion
52c . . . second channel forming portion
52c1 . . . via hole electrode
52d . . . through hole
61 . . . oxidant gas channel
62 . . . fuel gas channel

1. A fuel cell comprising: a power generating element comprising a solid oxide electrolyte layer, a first electrode arranged on one principal surface of the solid oxide electrolyte layer, and a second electrode arranged on the other principal surface of the solid oxide electrolyte layer;
a first separator comprising a first separator body arranged on the first electrode, and a plurality of first channel forming portions arranged at intervals from one another so as to protrude toward the first electrode side from the first separator body and form a plurality of first channels between the first separator body and the first electrode;
a second separator comprising a second separator body arranged on the second electrode, and a plurality of second channel forming portions arranged at intervals from one another so as to protrude toward the second electrode side from the second separator body and form a plurality of second channels between the second separator body and the second electrode; and
a first porous body disposed between the first channel forming portion and the first electrode.

2. The fuel cell according to claim 1, wherein the fuel cell further comprises a second porous body which is disposed between the second channel forming portion and the second electrode.

3. The fuel cell according to claim 2, wherein the first and second porous bodies comprise the same material.

4. The fuel cell according to claim 3, wherein at least one of the first and second porous bodies is disposed so as to cover only a portion of the electrode which faces the respective channel.

5. The fuel cell according to claim 1, wherein the first porous body is disposed so as to only cover a portion of the first electrode which faces the first channel.

6. The fuel cell according to claim 4, wherein the first separator comprises a via hole electrode extending from a surface of the first channel forming portion on a side opposite to the first separator body to a surface of the first separator body on a side opposite to the first channel forming portion, and
the first porous body comprises a conductive member.

7. The fuel cell according to claim 6, wherein the first porous body conductive member comprises a conductive ceramic.

8. The fuel cell according to claim 7, wherein the first porous body comprises the same material as that of the first electrode.

9. The fuel cell according to claim 5, wherein the first porous body comprises the same material as that of the first electrode.

10. The fuel cell according to claim 2, wherein the first separator comprises a via hole electrode extending from a surface of the first channel forming portion on a side opposite to the first separator body to a surface of the first separator body on a side opposite to the first channel forming portion, and
the first porous body comprises a conductive member.

11. The fuel cell according to claim 10, wherein the first porous body conductive member comprises a conductive ceramic.

12. The fuel cell according to claim 11, wherein the first porous body comprises the same material as that of the first electrode.

13. The fuel cell according to claim 1, wherein the first separator comprises a via hole electrode extending from a surface of the first channel forming portion on a side opposite to the first separator body to a surface of the first separator body on a side opposite to the first channel forming portion, and
the first porous body comprises a conductive member.

14. The fuel cell according to claim 13, wherein the first porous body conductive member comprises a conductive ceramic.

15. The fuel cell according to claim 14, wherein the first porous body comprises the same material as that of the first electrode.

16. The fuel cell according to claim 13, wherein the first porous body comprises the same material as that of the first electrode.

17. The fuel cell according to claim 1, wherein the first separator comprises a via hole electrode extending from a surface of the first channel forming portion on a side opposite to the first separator body to a surface of the first separator body on a side opposite to the first channel forming portion, and
the first porous body comprises a porous body main body comprising an insulating member, and an electrode in the porous body main body electrically connecting the via hole electrode and the first electrode.

18. The fuel cell according to claim 17, wherein the porous body main body comprises the same material as the first channel forming portion.

19. The fuel cell according to claim 18, wherein the porous body main body comprises the same material as the first separator body.

20. The fuel cell according to claim 17, wherein the porous body main body, and the first separator body are comprised of the same material.
